(19) United States
(12) Patent Application Publication
(10) Pub. No.: US 2016/0220440 A1
(43) Pub. Date: Aug. 4, 2016

(54) THERAPEUTIC TAPE

(71) Applicant: Michael J. Longo, Lodi, OH (US)

(72) Inventor: Michael J. Longo, Lodi, OH (US)

(21) Appl. No.: 14/613,047

(22) Filed: Feb. 3, 2015

(51) Int. Cl. A61H 7/00

(52) U.S. Cl. CPC A61H 7/001

(57) ABSTRACT

Provided is a therapeutic tape comprising a substantially planar woven fiber layer, an adhesive layer engaged with the first side of the woven fiber layer, and a protective layer engaged with the first side of the adhesive layer. The woven fiber layer comprises a first side, and a second side opposite said first side; extends in a first therapy direction; extends in a second therapy direction substantially perpendicular to the first therapy direction; and is composed of a weave of fibers comprising a first set of fibers extending in a first fiber direction changeable with respect to the first therapy direction and a second set of fibers interwoven with the first set of fibers and extending in a second fiber direction changeable with respect to the first therapy direction.

### TECHNICAL FIELD

The present subject matter generally relates to medical and therapeutic devices. More particularly, the present subject matter relates to therapeutic tape adapted for kinesiotherapy and other medical uses.

### BACKGROUND AND SUMMARY

Therapeutic taping the skin of a person or animal in order to provide therapeutic action is a medically useful process. Some such therapeutic taping may be kinesiotherapeutic taping which may provide support, may stimulate neuro-muscular tissues proximate to the taped region, and may dilate, open, or otherwise facilitate flow in blood or lymphatic vessels.

Existing therapeutic tape is not adapted to provide elastic response in more than one direction. Existing therapeutic tape is not adapted to provide a substantially therapeutic force in more than one dimension. It remains desirable to develop therapeutic tape which improves therapeutic action through adaptations to provide elastic response and a substantially therapeutic force in more than one direction.

Provided is a therapeutic tape comprising a substantially planar woven fiber layer, an adhesive layer engaged with the first side of the woven fiber layer, and a protective layer engaged with the first side of the adhesive layer. The woven fiber layer comprises a first side, and a second side opposite said first side; extends in a first therapy direction; extends in a second therapy direction substantially perpendicular to the first therapy direction; and is composed of a weave of fibers comprising a first set of fibers extending in a first fiber direction changeable with respect to the first therapy direction and a second set of fibers interwoven with the first set of fibers and extending in a second fiber direction changeable with respect to the first therapy direction.

### BRIEF DESCRIPTION OF THE DRAWINGS

FIG. 1A is a view depicting one embodiment of a section of therapeutic tape.

FIG. 1B is view of the embodiment of the section of therapeutic tape of FIG. 1, wherein the tape has been pulled in the vertical direction as shown.

FIG. 1C is view of the embodiment of the section of therapeutic tape of FIG. 1, wherein the tape has been pulled in the horizontal direction as shown.

FIG. 1D is cross-sectional view of the embodiment of the section of therapeutic tape of FIG. 1.

FIG. 2A is a view of one embodiment of a weave in a first stress state.

FIG. 2B is a view of the weave of FIG. 2A in a second stress state.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### DETAILED DESCRIPTION

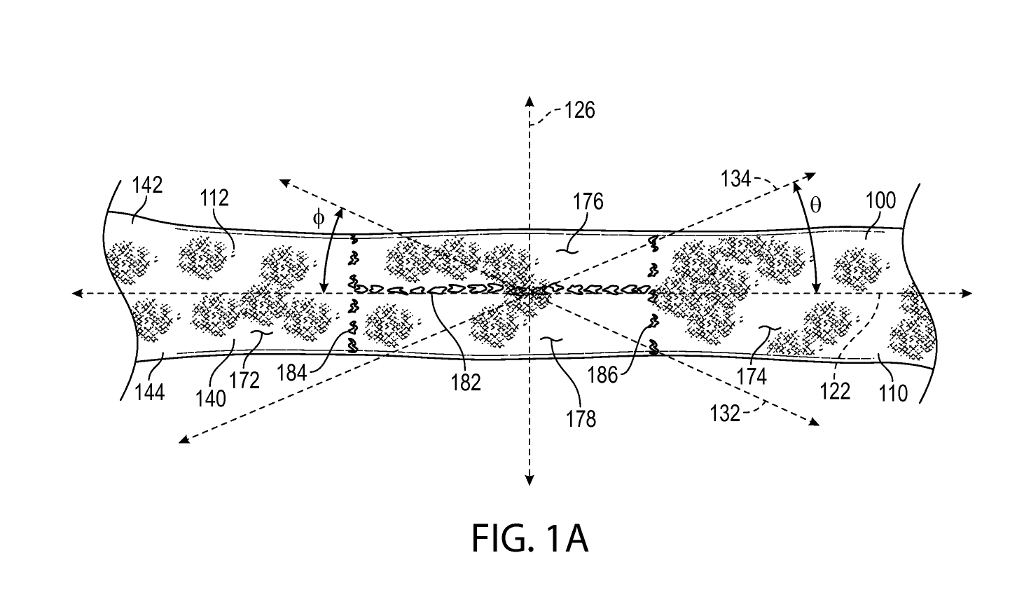

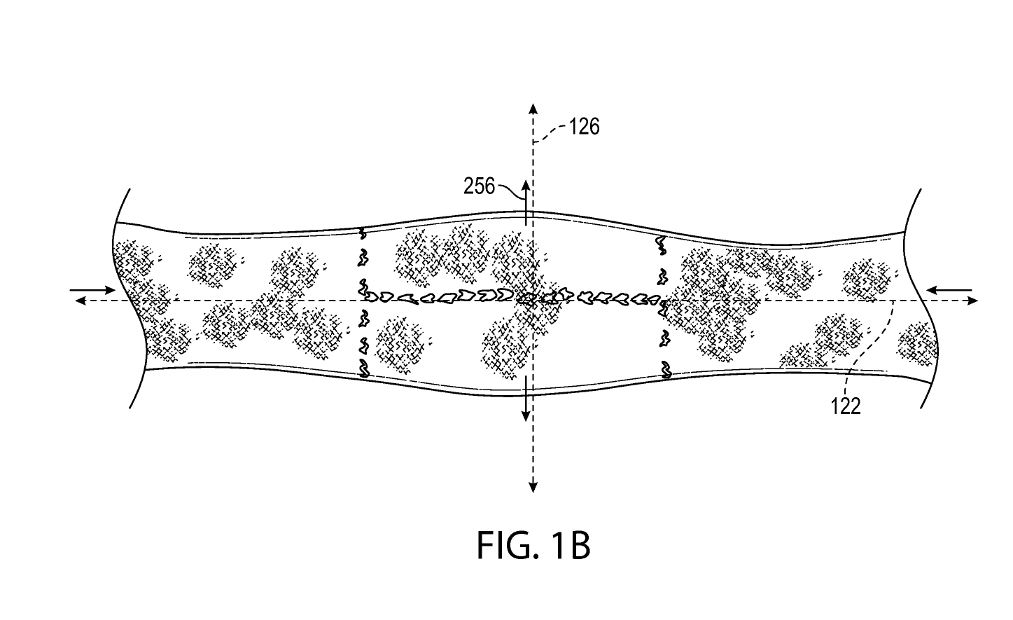

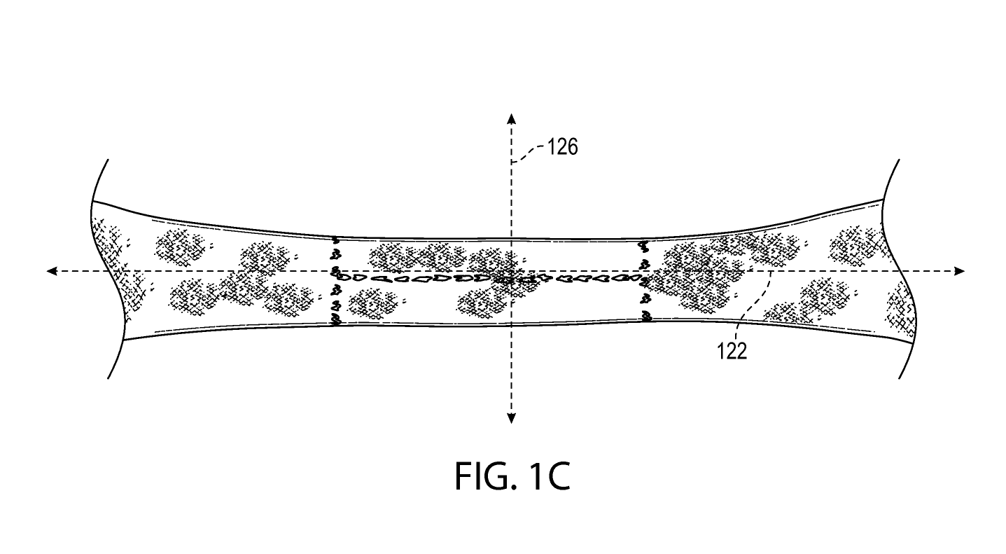

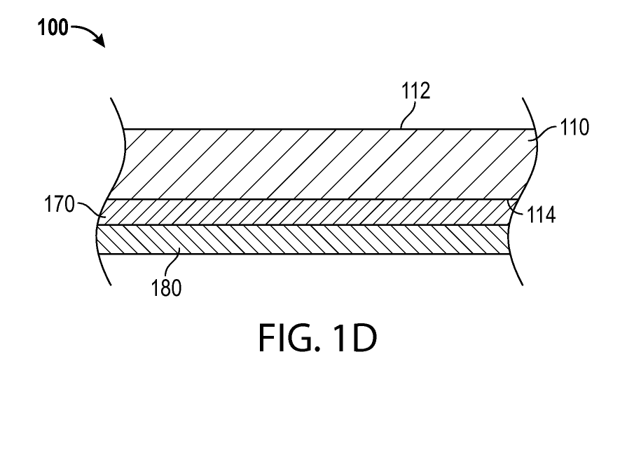

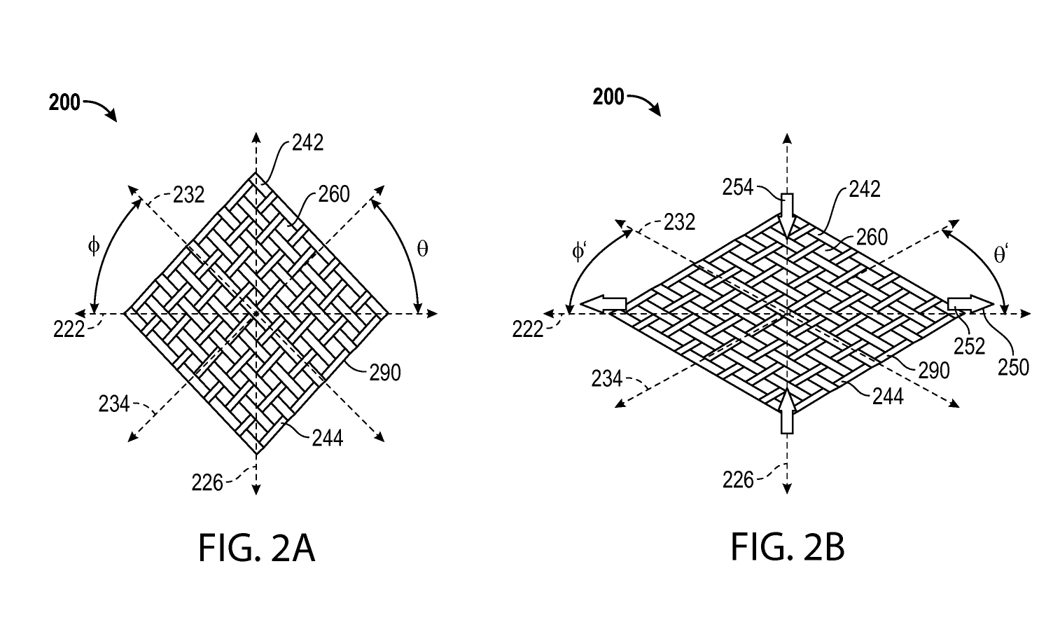

Referring now to FIGS. 1A-1D, and 2A-2B, shown are non-limiting embodiments of a therapeutic tape adapted for kinesiotherapy and other applications.

In a first non-limiting embodiment as shown in FIGS. 1A-1D a therapeutic tape 100 is shown. As used herein, unless otherwise noted, the therapeutic tape refers to tape which may be used for kinesiotherapy, sometimes also referred to as “kinesiotape”, or certain other medical purposes as disclosed herein. These certain other medical purposes may be directed to skin and the tissues proximate thereto and may include, without limitation, dermal lifting, affecting blood flow, affecting lymphatic drainage, edema reduction, pain inhibition, muscle facilitation, proprioceptive facilitation, support, and healing. The therapeutic tape 100 comprises a woven fiber layer 110, an adhesive layer 170, and a protective layer 180.

The woven fiber layer 110 is substantially planar comprising a first side 112 and a second side 114 opposite the first side. The adhesive layer 170 may be engaged with the first side 112 of the woven layer 110. The protective layer 180 may be engaged with the adhesive layer. The woven fiber layer 110 may extend in a first therapy direction 122 and in a second therapy direction 126 that is substantially perpendicular to the first therapy direction 122.

As used herein, the term “therapy direction”, as in the first therapy direction 122 and second therapy direction 126, refers to the direction along which an application force is applied to the therapeutic tape 100 when in use and to the direction of action of therapeutic force reactively produced by the therapeutic tape 100 when in use. In certain embodiments, as shown in FIGS. 1A-1D, the therapeutic tape 100 is elongated along the first therapy direction 122. The therapeutic tape 100 may elongated along the first therapy direction 122 and may be provided either as a very long strap of material extending in the first therapy direction 122 which is cut to usable lengths prior to use, or as pre-cut straps which may be used in the pre-cut length or further cut to length by a user.

The woven fiber layer 110 may be composed of a weave of fibers 140 in which the weave comprises a first set of fibers 142 extending in a first fiber direction 132, and a second set of fibers 144 interwoven with the first set of fibers 142 and extending in a second fiber direction 134. In certain embodiments, the first fiber direction 132 is directed along some first bias angle, θ, with respect to the first therapy direction 122 wherein the first bias angle, φ, is changeable with respect to the first therapy direction 122. In certain embodiments, the second fiber direction 134 is directed along some second bias angle, θ, with respect to the first therapy direction 122 wherein the second bias angle, θ, is changeable with respect to the first therapy direction 122. The first bias angle, φ, and the second bias angle, θ, may be changed when the first set of fibers 142 and the second set of fibers 144, rotate with respect to one another.

In the non-limiting embodiment of FIGS. 2A and 2B, shown are a first set of fibers 242 extending in a first fiber direction 232, and a second set of fibers 244 interwoven with the first set of fibers 242 and extending in a second fiber direction 234, where either the first fiber direction 232 or the second fiber direction 234, or both directions 232, 234 are changeable. In a first stress state, such as without limitation, an unstressed state or in a state absent externally applied stress or force, as shown in FIG. 2A, the first set of fibers 242 extend in a first fiber direction 232 along first bias angle, φ, with respect to the first therapy direction 222 and the second set of fibers 244 extend in a second fiber direction 234 along second bias angle θ with respect to the first therapy direction 222. In a second stress state, such as without limitation, a state with externally applied stress or force 252, as shown in FIG. 2B, the first set of fibers 242 extend in a first fiber direction 232 along modified first bias angle, φ′, with respect to the first therapy direction 222 and the second set of fibers 244 extend in a second fiber direction 234 along modified second bias angle θ′ with respect to the first therapy direction 222 where φ differs from φ′ (by some angle Δφ), or where θ differs from θ′ (by some angle Δθ), or both. FIG. 2B shows pairs of external force vectors 250 indicating that the tensile application force 252 applied to the weave as indicated by the horizontal vectors 250 produces a reactive force 254 in the vertical direction as indicated by the vertical vectors 250. That is, the tensile application force 252 strains the interweave cells 260, each of which is defined by the bordering fibers 242, 244, elongating the cell 260 in first therapy direction 222, and, in reaction, the cell 260 shrinks in the second therapy direction 226. Stated in a different way, a tensile application force 252 applied along the first therapy direction 222 produces a contractile force 254 in the second therapy direction 226. Similarly and analogously, a tensile force (not shown) applied along the second therapy direction 226 produces a contractile force (not shown) in the first therapy direction 222.

Without limitation, in certain embodiments, the angle φ between first fiber direction 232 and the first therapy direction 222 may be changed by application of an externally applied stress or force such as, without limitation force 252. Without limitation, in certain embodiments, the angle φ between first fiber direction 232 and the first therapy direction 222 is between 15 and 75 degrees and the angle φ between first fiber direction 232 and the first therapy direction 222 may be changed by application of an externally applied stress or force such as, without limitation force 252. Without limitation, in certain embodiments, the angle φ between first fiber direction 232 and the first therapy direction 222 is between 30 and 60 degrees and the angle φ between first fiber direction 232 and the first therapy direction 222 may be changed by application of an externally applied stress or force such as, without limitation force 252.

The first set of fibers 142, 242 may be substantially rigid, substantially elastomeric, or somewhere therebetween. The first set of fibers 142, 242 may comprise polymers, copolymers, metal fibers, nylon, latex, polyvinyl chloride, polypropylene, polyethylene, polystyrene, styrenic block copolymers, polyether ether ketone, thermoplastics, such as, without limitation, ABS, PC and PET, aramid, other materials chosen with good engineering judgment, or combinations thereof. In some embodiments, the first set of fibers 142, 242 or the material of which the first set of fibers 142, 242 are comprised or both, have a modulus of elasticity of 2 GPA or greater. In some embodiments, the first set of fibers 142, 242 or the material of which the first set of fibers 142, 242 are comprised or both, have a modulus of elasticity of 58 GPA or greater.

Without limitation, in certain embodiments, the angle θ between second fiber direction 234 and the first therapy direction 222 may be changed by application of an externally applied stress or force such as, without limitation force 252. Without limitation, in certain embodiments, the angle θ between second fiber direction 234 and the first therapy direction 222 is between 15 and 75 degrees and the angle θ between second fiber direction 234 and the first therapy direction 222 may be changed by application of an externally applied stress or force such as, without limitation force 252. Without limitation, in certain embodiments, the angle θ between second fiber direction 234 and the first therapy direction 222 is between 30 and 60 degrees and the angle θ between second fiber direction 234 and the first therapy direction 222 may be changed by application of an externally applied stress or force such as, without limitation force 252.

The second set of fibers 144, 244 may be substantially rigid, substantially elastomeric, or somewhere therebetween. The second set of fibers 144, 244 may comprise polymers, copolymers, metal fibers, nylon, latex, polyvinyl chloride, polypropylene, polyethylene, polystyrene, styrenic block copolymers, polyether ether ketone, thermoplastics, such as, without limitation, ABS, PC and PET, aramid, other materials chosen with good engineering judgment, or combinations thereof. In some embodiments, the second set of fibers 144, 244 or the material of which the second set of fibers 144, 244 are comprised or both, have a modulus of elasticity of 2 GPA or greater. In some embodiments, the second set of fibers 144, 244 or the material of which the second set of fibers 144, 244 are comprised or both, have a modulus of elasticity of 58 GPA or greater.

The therapeutic tape 100, 200 as applied to the skin of a human or animal will also be subject to a restorative force opposite an applied tensile application force. In some embodiments, the natural elastic character of the skin and underlying tissue imparts a restorative force to the therapeutic tape applied thereto. In some embodiments, the therapeutic tape may comprise one or more elastomeric materials such as, without limitation, elastic fibers 290. While in some embodiments elastic fibers 290 may extend in any direction, in one non-limiting embodiment, the therapeutic tape 100, 200 comprises elastic fibers extending parallel to the first therapy direction 122, 222 or the second therapy direction 126, 226 or both directions 122, 222, 126, 226. In some embodiments, the elastic fibers 290 or the material of which the elastic fibers 290 are comprised or both, have a modulus of elasticity of 0.5 GPA or greater.

The adhesive layer 170 may comprise any medical adhesive chosen with good engineering judgment. In some embodiments the adhesive layer 170 may comprise epoxy, cyanoacrylate, silicone, or combinations thereof. In some embodiments, the adhesive layer 170 may offer water resistance, such as, and without limitation, resistance to sweat and submersion, when applied correctly.

The protective layer 180 may comprise any protective material chosen with good engineering judgment. In some embodiments the protective layer 180 may comprise a coated polymer.

Referring now to the non-limiting embodiments shown in FIGS. 1A-1D and 2A-2B, the therapeutic tape 100, 200 may be applied to the skin of a subject human or animal. There are a variety of acceptable methods of application of the therapeutic tape 100, 200 to the skin of a subject human or animal and the methods of application chosen may depending on factors including desired dermal lift, injury type, body part size, etc. As will be discussed further below, proper application of the therapeutic tape 100, 200 requires little or no medical knowledge, but a user with substantial medical knowledgeable may be able to select amongst the various acceptable methods of application of the therapeutic tape 100, 200 to more finely tailor the resulting benefits. Application of the therapeutic tape 100, 200 to the skin of the subject may comprise a user of the therapeutic tape 100, 200 exposing at least a first part 172 of the adhesive layer 170 by disengaging all or a portion of the protective layer 180 therefrom to expose the adhesive layer 170 thereunder; engaging the first part 172 of the adhesive layer 170 with the skin of the subject; pulling the therapeutic tape 100, 200 in the first therapy direction 122, 222 to create a substantially therapeutic tensile force 252 in the therapeutic tape 100, 200 in the first therapy direction 122, 222; and engaging a second part 174 of the adhesive layer 170, opposite from the first part 172 of the adhesive layer 170 in the first therapy direction 122, 222, with the skin of the subject. It should be understood that the step of pulling the therapeutic tape 100, 200 in the first therapy direction 122, 222 to create a substantially therapeutic tensile force 252 in the therapeutic tape 100, 200 in the first therapy direction 122, 222 will also, by the above described nature of the therapeutic tape 100, 200 cause a compressive strain in the therapeutic tape 100, 200 in the second therapy direction 126, 226 as shown in FIG. 1C. In FIG. 1C the therapeutic tape 100 of FIG. 1A has been subjected to an applied tensile force in the first therapy direction 122 and as, a result of this applied tensile force, the therapeutic tape 100 has elongated in the first therapy direction 122 and contracted in the second therapy direction 126 compared to its state as shown in FIG. 1A. It should also be understood that application of the therapeutic tape 100, 200 which has been subjected to a tensile stress to the skin of the subject will induce a reactive compressive stress in the skin and the other local tissues of the subject. The nature of this reactive compressive stress will be discussed below. In addition to the above steps, application of the therapeutic tape 100, 200 to the skin of the subject may also comprise a user of the therapeutic tape 100, 200 pulling the therapeutic tape 100, 200 in the second therapy direction 126, 226 to create a substantially therapeutic tensile force in the therapeutic tape 100, 200 in the second therapy direction 126, 226; engaging a third part 176 of the adhesive layer 170 with the skin; and engaging a fourth part 178 of the adhesive layer 170 opposite from the third part 176 of the adhesive layer 170 in the second therapy direction 126, 226, with the skin. It should be understood that the step of pulling the therapeutic tape 100, 200 in the second therapy direction 126, 226 to create a substantially therapeutic tensile force 256 in the therapeutic tape 100, 200 in the second therapy direction 126, 226 will also, by the above described nature of the therapeutic tape 100, 200 cause a compressive strain in the therapeutic tape 100, 200 in the first therapy direction 126, 226 as shown in FIG. 1B. In FIG. 1B the therapeutic tape 100 of FIG. 1A has been subjected to an applied tensile force 256 in the second therapy direction 122 and as, a result of this applied tensile force 256, the therapeutic tape 100 has elongated in the second therapy direction 126 and contracted in the first therapy direction 122 compared to its state as shown in FIG. 1A. In another method, application of the therapeutic tape 100, 200 to the skin of the subject may comprise a user of the therapeutic tape 100, 200 exposing first part 172, second part 174, third part 176, and fourth part 178 of the adhesive layer 170 by disengaging the protective layer 180 therefrom to expose the adhesive layer 170 thereunder; pulling the therapeutic tape 100, 200 in the first therapy direction 122, 222 to create a substantially therapeutic tensile force 252 in the therapeutic tape 100, 200 in the first therapy direction 122, 222; and engaging the pulled therapeutic tape 100, 200 with the skin of the subject. In another method, application of the therapeutic tape 100, 200 to the skin of the subject may comprise a user of the therapeutic tape 100, 200 exposing at least a first part 172 of the adhesive layer 170 by disengaging all or a portion of the protective layer 180 therefrom to expose the adhesive layer 170 thereunder; engaging the first part 172 of the adhesive layer 170 with the skin of the subject; pulling the therapeutic tape 100, 200 in the first therapy direction 122, 222 to create a substantially therapeutic tensile force 252 in the therapeutic tape 100, 200 in the first therapy direction 122, 222; engaging a second part 174 of the adhesive layer 170, opposite from the first part 172 of the adhesive layer 170 in the first therapy direction 122, 222, with the skin of the subject; exposing a third part 176 of the adhesive layer; exposing a fourth part 178 of the adhesive layer; either a) not applying tension in the second therapy direction 126, 226 or b) apply tension in the second therapy direction 126, 226 by the pulling the third part 176 without pulling on fourth part 178, or c) apply tension in the second therapy direction 126, 226 by the pulling the third part 176 and subsequently pulling on fourth part 178, or d) apply tension in the second therapy direction 126, 226 by the pulling the third part 176 and simultaneously pulling on fourth part 178; and engaging the third part 176 and the fourth part 178 with the skin of the subject. It should be understood that the present subject matter encompasses methods in which engagement of the parts 172, 174, 176, 178 may be done in any desired order and with any desired tension.

It should be understood that the provided subject matter requires no or very little anatomical knowledge to use. That is, rather than requiring some knowledge of kinesiology, muscular origin, muscular insertion, and muscular action for proper application and benefits, the present subject matter can be used successfully in kinesiology applications by a user with very little knowledge of kinesiology, muscular origin, muscular insertion, and muscular action for proper application and benefits. The present subject matter provides ease of application and relief simply by stretching the tape and adhering to the site of injury.

In some embodiments the protective layer 180 has one or more parting lines or perforations or separations. In the embodiment shown in FIG. 1A the protective layer 180 has one or more parting lines or perforations or separations indicated by the dashed marks 182, 184, 186.

The biaxial nature of the therapeutic tape 100, 200 allows the tape 100, 200 to be subjected to a tensile force in the first therapy direction 122, 222, or the second therapy direction 126, 226, or both the first therapy direction 122, 222 and the second therapy direction 126, 226 simultaneously. Application of therapeutic tape 100, 200 having a tensile force applied thereto to the skin of a subject human or animal creates a compressive force in the skin to which the therapeutic tape 100, 200 is applied as well as creating a compressive force in the local tissues. This compressive force in the skin and local tissue can buckle the skin and local tissue in the relevant therapeutic directions 122, 222, 126, 226 direction creating dermal tenting or dermal doming in the local region. This dermal tenting or dermal doming can dramatically increase medical response including, but not limited to, blood flow, lymphatic flow, or other circulation in the local tissue as well as promoting pain relief and healing. When the therapeutic tape 100, 200 as applied is subjected to a tensile force in both the first therapy direction 122, 222 and the second therapy direction 126, 226 simultaneously, the resulting compressive forces can buckle the skin and local tissue in both therapeutic directions simultaneously creating dermal lifting or dermal doming in both therapeutic directions; that is biaxial dermal lifting or dermal doming. This biaxial dermal lifting or dermal doming can increase medical response over that of uni-axial dermal lifting or dermal doming. The therapeutic tape 100, 200 may also be used to provide support.

The present subject matter may be embodied in other forms without departing from the spirit and the essential attributes thereof, and, accordingly, reference should be made to the appended claims, rather than to the foregoing specification, as indicating the scope of the subject matter.

What is claimed:

1. A therapeutic tape comprising:
a substantially planar woven fiber layer, comprising a first side, and a second side opposite said first side, wherein said woven fiber layer
extends in a first therapy direction,
extends in a second therapy direction substantially perpendicular to the first therapy direction, and
is composed of a weave of fibers
comprising a first set of fibers
extending in a first fiber direction changeable with respect to the first therapy direction, and
comprising a second set of fibers,
interwoven with the first set of fibers,
extending in a second fiber direction changeable with respect to the first therapy direction;
an adhesive layer engaged with the first side of the woven fiber layer; and
a protective layer engaged with the adhesive layer.

2. The therapeutic tape of claim 1, wherein a tensile force applied along the first therapy direction produces a contractile force in the second therapy direction, and a tensile force applied along the second therapy direction produces a contractile force in the first therapy direction.

3. The therapeutic tape of claim 2, wherein the first fiber direction may be changeable within the range between 15 and 75 degrees with respect to the first therapy direction.

4. The therapeutic tape of claim 3, wherein the first set of fibers has a modulus of elasticity of 2 GPA or greater.

5. The therapeutic tape of claim 4, wherein the second fiber direction may be changeable within the range between 15 and 75 degrees with respect to the first therapy direction.

6. The therapeutic tape of claim 5, wherein the second set of fibers has a modulus of elasticity of 2 GPA or greater.

7. The therapeutic tape of claim 6, wherein the first fiber direction may be changeable within the range between 30 and 60 degrees with respect to the first therapy direction.

8. The therapeutic tape of claim 7, wherein the first set of fibers has a modulus of elasticity of 58 GPA or greater.

9. The therapeutic tape of claim 8, wherein the second fiber direction may be changeable within the range between 30 and 60 degrees with respect to the first therapy direction.

10. The therapeutic tape of claim 9, wherein the second set of fibers has a modulus of elasticity of 58 GPA or greater.

11. The therapeutic tape of claim 10, further comprising one or more elastic fibers having a modulus of elasticity of 0.5 GPA or greater oriented substantially parallel to a therapy direction.

12. A method of application of a therapeutic tape comprising:
providing a therapeutic tape comprising
a substantially planar woven fiber layer, comprising a first side, and a second side opposite said first side, wherein said woven fiber layer
extends in a first therapy direction,
extends in a second therapy direction substantially perpendicular to the first therapy direction,
is composed of a weave of fibers
comprising a first set of fibers
extending in a first fiber direction changeable with respect to the first therapy direction, and
comprising a second set of fibers,
interwoven with the first set of fibers,
extending in a second fiber direction changeable with respect to the first therapy direction, and
wherein the weave of fibers is adapted to function in such a way that a tensile force in the first therapy direction produces a contractile force in the second therapy direction, and a tensile force in the second therapy direction produces a contractile force in the first therapy direction,
an adhesive layer engaged with the first side of the woven fiber layer,
a protective layer engaged with the first side of the adhesive layer; and
providing a human or animal having skin;
exposing at least a first part of the adhesive layer by disengaging the protective layer therefrom;
engaging a first part of the adhesive layer with the skin;
pulling the tape in the first therapy direction to create a substantially therapeutic tensile force in the first therapy direction;
engaging a second part of the adhesive layer, opposite from the first part of the adhesive in the first therapy direction, with the skin;
pulling the tape in the second therapy direction to create a substantially therapeutic tensile force in the second therapy direction;
engaging a third part of the adhesive layer with the skin;
engaging a fourth part of the adhesive layer opposite from the third part of the adhesive in the second therapy direction, with the skin.

13. The method of application of a therapeutic tape of claim 12, wherein
the first set of fibers has a modulus of elasticity of 58 GPA or greater; and
the second set of fibers has a modulus of elasticity of 58 GPA or greater.

14. The method of application of a therapeutic tape of claim 13, wherein the first fiber direction may be changeable within the range between 15 and 75 degrees with respect to the first therapy direction.

15. The method of application of a therapeutic tape of claim 14, wherein the second fiber direction may be changeable within the range between 15 an 75 degrees with respect to the first therapy direction.

16. The method of application of a therapeutic tape of claim 15, further comprising one or more elastic fibers having a modulus of elasticity of 0.5 GPA or greater oriented substantially parallel to a therapy direction.

17. A method of providing therapy comprising:
providing a therapeutic tape comprising
a substantially planar woven fiber layer, comprising a first side, and a second side opposite said first side, wherein said woven fiber layer
extends in a first therapy direction,
extends in a second therapy direction substantially perpendicular to the first therapy direction,
is composed of a weave of fibers
comprising a first set of fibers
extending in a first fiber direction changeable with respect to the first therapy direction, and
comprising a second set of fibers,
interwoven with the first set of fibers,
extending in a second fiber direction changeable with respect to the first therapy direction, and
wherein the weave of fibers is adapted to function in such a way that a tensile force in the first therapy direction produces a contractile force in the second therapy direction, and a tensile force in the second therapy direction produces a contractile force in the first therapy direction,
an adhesive layer engaged with the first side of the woven fiber layer,
a protective layer engaged with the first side of the adhesive layer; and
providing a human or animal having skin; and
engaging the therapeutic tape with the skin in such a manner that the tape applies a substantially therapeutic compressive force to the skin in two directions simultaneously.

18. The method of providing therapy of claim 17, wherein the tape applies a substantially therapeutic compressive force to the skin in the first therapy direction and the second therapy direction simultaneously.

19. The method of providing therapy of claim 18, wherein
the first fiber direction may be changeable within the range between 15 and 75 degrees with respect to the first therapy direction; and
the second fiber direction may be changeable within the range between 15 and 75 degrees with respect to the first therapy direction.

20. The method of providing therapy of claim 19, wherein
the first set of fibers has a modulus of elasticity of 58 GPA or greater; and
the second set of fibers has a modulus of elasticity of 58 GPA or greater.
